(19) United States
(12) Patent Application Publication
(10) Pub. No.: US 2015/0338875 A1
(43) Pub. Date: Nov. 26, 2015

(54) GRASPABLE MOBILE CONTROL ELEMENT SIMULATING A JOYSTICK OR THE LIKE WITH AT LEAST ONE CONTROL ELEMENT WITH PHYSICAL END STOP, AND ASSOCIATED METHOD OF SIMULATION

(71) Applicant: MOVEA, Grenoble (FR)

(72) Inventor: Guillame Aujay, Grenoble (FR)

(73) Assignee: MOVEA, Grenoble (FR)

(21) Appl. No.: 14/759,259

(22) PCT Filed: Dec. 20, 2013
(86) PCT No.: PCT/EP2013/077699

§ 371 Date: Jul. 6, 2015

(30) Foreign Application Priority Data
Jan. 4, 2013 (FR) 1350051

(51) Int. Cl. G05G 9/047; G05B 15/02

(52) U.S. Cl. CPC G05G 9/047; G05B 15/02

(57) ABSTRACT

A control system with a graspable mobile control element, including:
means of determining the values of components of the gravity vector along at least one axis of a moving reference frame tied to the mobile element, including a motion sensor assembly including an accelerometer with at least one axis for measurements and a gyroscope with at least one measurement axis, by fusion of measurements delivered by the accelerometer and the gyroscope;
processing means suitable for converting, by direct application of a gain, said components into output signals corresponding to those of a joystick equivalent provided with at least one control element with a physical stop; and
   means of delivery of said output signals corresponding to said joystick equivalent with at least one control element with a physical stop.

### FIELD OF THE INVENTION

Various embodiments of the invention relate to a graspable mobile control element simulating a joystick with at least one control element with a physical stop, and an associated method of simulation.

### BACKGROUND OF THE INVENTION

Systems for remote control by movement may be used for interacting with screens such as connected television sets. The remote control may be in a pointing mode for controlling a cursor on the screen, but also in a gesture recognition mode, in which the movement remotely transmitted by the user is translated into commands. In addition, the movement of the remote control may be used for controlling games, e.g. for imitating a steering wheel used to control an automobile racing game, or a control element in the form of a lever or stick for flight simulation games.

In general, games are designed to be controlled by a lever with at least one control element with a physical stop or joystick, which means that the game software converts an input via the joystick into actions in the game.

U.S. Pat. No. 8,137,195 relates to the use of a remote control with a motion sensor for emulated games devices. The patent provides methods for adapting movement characteristics according to the type of device being emulated. For example, in a shooting game, the movement characteristics may be adapted according to the type of weapon used by the avatar. The movement device provided is in direct communication with the (games) application. The advantage is that the movement characteristic of the game device feature can be emulated in detail according to the (games) application, but the drawback is that this also involves an adaptation of the application.

### SUMMARY OF EMBODIMENTS OF THE INVENTION

One object of an embodiment of the invention is to provide a solution that does not require an adaptation of the application.

One object of an embodiment of the invention is to be able to simulate a joystick with at least one control element with a physical stop.

According to one embodiment of the invention, a control system is provided with a graspable mobile control element, including:
means for determining the values of components of the gravity vector along at least one axis of a moving reference frame tied to the mobile element, including a motion sensor assembly including an accelerometer with at least one axis for measurements and a gyroscope with at least one measurement axis, by fusion of measurements delivered by the accelerometer and the gyroscope;
processing means configured to convert, by direct application of a gain, said components into output signals corresponding to those of a joystick equivalent provided with at least one control element with a physical stop; and
means for delivery of said output signals corresponding to said joystick equivalent with at least one control element with a physical stop.

It is thus possible to simulate a joystick or joystick equivalent with at least one control element with a physical stop based on a graspable mobile control element. Many games can be controlled by a joystick, and thus, by simulating a joystick, the remote control can be used with many games without needing to adapt the game. The processing and delivery means may be internal and/or external to the graspable mobile control element.

Accordingly, so that the remote control may be used with the majority of games without needing to adapt the game software, it is convenient to convert the movement of the remote control into signals for a joystick with at least one physical stop. In other words, even if the user controls the game via the movement of a remote control, the system perceives that it is controlled by a joystick.

The fusion may be partial or complete.

According to dynamic situations, the proper acceleration of the mobile control element is also measured, and as a single accelerometer may lack reliability, the combined use of an accelerometer and a gyroscope can be used to improve the accuracy of the system.

In one embodiment, said processing means are configured to determine a neutral reference position from a mapping between the axes of said moving reference frame and the axes of said joystick equivalent, and an application of an offset to said components.

Thus, it is possible to set the parameters of a reference position corresponding to the released position of the corresponding joystick (or joystick with at least one control element with a physical stop).

According to one embodiment, said processing means are, in addition, are configured to not take into account, about the neutral reference position of the mobile element, angular movements, along at least one of the axes of the mobile element, below a respective threshold.

Thus small movements, generally not representative of an intention of the user to move the control element, are not taken into account. This may be done on a single axis or several axes independently, which enables having a less responsive or less reactive control element when the user does not intentionally change the orientation of the control element, which is more pleasant for the user. For example, in a racing game, this can be used so as not to have a reactive or responsive steering wheel with uncontrolled movements about the neutral reference position.

In one embodiment, said processing means are configured to simulate said physical stop based on an angle limit beyond which said stop is deemed to be reached.

The axes of the accelerometer and of the moving reference frame tied to the mobile element may be identical, or else a simple transformation may be used to switch from the accelerometer axes to the moving reference frame axes.

In one embodiment, said determining means are configured to determine said values of said components of the gravity vector from an attitude matrix obtained by a fusion of measurements delivered by the accelerometer and the gyroscope.

Since the use of an attitude matrix is universal, the matrix calculation techniques are of little importance.

For example, said motion sensor assembly further includes a magnetometer.

A magnetometer may be used instead of the gyroscope, or in addition to the gyroscope, and can be used to provide an absolute orientation in the terrestrial reference frame (magnetic field).

The mobile element may be provided with at least one physical or virtual button (e.g. represented on a touch screen), mapped to the buttons of said joystick equivalent.

Thus the control buttons of the joystick equivalent are also simulated.

The mobile element may be a remote control, a mobile phone, a touch pad, or a joystick provided with at least one motion sensor.

According to another embodiment of the invention, a method for simulating a joystick equivalent with at least one control element with a physical stop is also provided, based on a graspable control element, including the steps of:
determining the values of components of the gravity vector along at least one axis of a moving reference frame tied to the mobile element, from the data supplied by a motion sensor assembly including an accelerometer with at least one axis for measurements and a gyroscope with at least one measurement axis, by fusion of measurements delivered by the accelerometer and the gyroscope;
converting, by direct application of a gain, said components into output signals corresponding to those of a joystick equivalent with at least one control element with a physical stop; and
delivering said output signals corresponding to said joystick equivalent with at least one control element with a physical stop.

### BRIEF DESCRIPTION OF THE DRAWINGS

The invention will be better understood from the study of some embodiments described by way of non-restrictive examples and illustrated by the accompanying drawings in which:

FIG. 1 schematically illustrates an embodiment of a graspable mobile control element, according to one aspect of the invention;

FIGS. 2a and 2b illustrate respectively an actual joystick with one and two control elements with a physical stop, according to the prior art;

FIGS. 3a and 3b illustrate an example of use of an embodiment of the invention for a racing game;

FIGS. 4a and 4b illustrate an example of use of an embodiment of the invention for a flight simulation game;

FIG. 5 schematically illustrates an implementation of the method, according to one an embodiment of the invention;

FIG. 6 schematically represents the mechanical stop and the limit angle of a control element of a joystick equivalent;

FIG. 7 schematically illustrates the implementation of an angle limit for simulating at least one physical stop, according to an embodiment of the invention;

FIG. 8 schematically illustrates the implementation of not taking into account too weak or unintentional movements according to the prior art, in the case of an actual joystick with a control lever with at least one physical stop;

FIG. 9 schematically illustrates the implementation of not taking into account too weak or unintentional movements along at least one of the axes of the mobile element, according to an embodiment of the invention; and

FIG. 10 schematically illustrates an example of a complete embodiment of the invention, with all the optional elements, according to one aspect of the invention.

### DETAILED DESCRIPTION OF THE PREFERRED EMBODIMENTS

In all the figures, elements having the same references are similar.

FIG. 1 illustrates an example of a system with a graspable mobile control element EM according to an embodiment of the invention, including a module DET for determining the values of components of the gravity vector along at least one axis of a moving reference frame RM tied to the mobile element, a processing module TRT suitable for converting said components into output signals corresponding to a joystick equivalent (or joystick) with at least one control element with a physical stop, by direct application of a gain K, and a module OUT for delivering said output signals corresponding to said joystick equivalent including a control element with a physical stop.

The processing TRT and delivery OUT means may be internal and/or external to the graspable mobile control element EM. In the following description, by way of non-restrictive example, the processing TRT and delivery OUT means are internal to the graspable mobile control element EM.

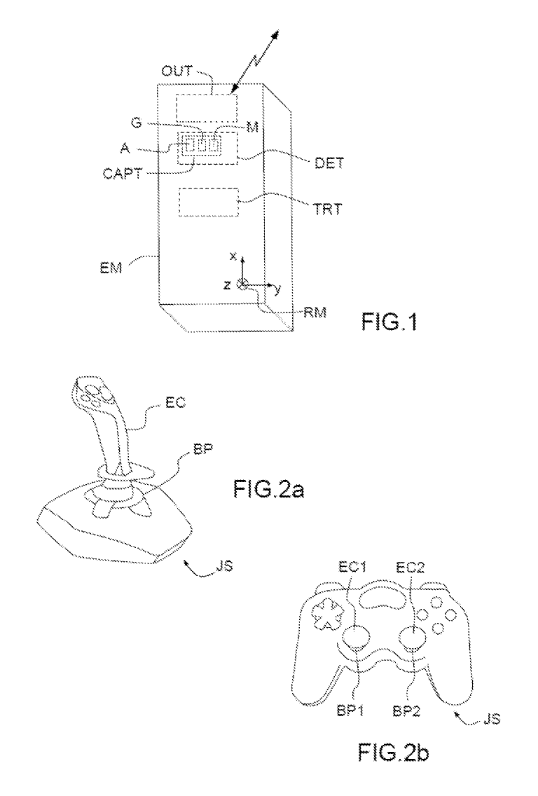

FIGS. 2a and 2b respectively illustrate an actual joystick JS with a control element EC with a physical stop BP, and two control elements EC1, EC2 respectively with a physical stop BP1 and BP2 of the prior art.

The graspable mobile control element EM may be a remote control, a mobile phone, a touch pad, or a joystick provided with at least one motion sensor.

The direct application of the gain K is very simple and requires only a simple processor. The normalized values of the components of the gravity vector vary between −1 and 1. Thus, the application of a gain for mapping the minimum (−1) and the maximum (1) with the minimum and maximum values of the output signal of a joystick equivalent, which depend on the number of bits used (generally 16 bits).

For example, the determining module DET includes a motion sensor assembly CAPT which may include an accelerometer A, and optionally a gyroscope G and/or a magnetometer M.

When the motion sensor assembly CAPT includes an accelerometer A with at least one axis for measurements, the determining means DET may be configured to determine the values of the components of the gravity vector by normalizing the measurements along the axes of the moving reference frame RM.

Of course, either the axes of the moving reference frame RM and those of the sensors of the motion sensor assembly CAPT are identical, or a simple transformation may be used to pass from the axes of the motion sensor assembly CAPT to the axes of the moving reference frame RM.

When the motion sensor assembly CAPT includes an accelerometer A with at least one axis for measurements and a gyroscope G with at least one axis for measurements, the determining means DET are configured to determine the values of the components of the gravity vector by fusion of measurements delivered by the accelerometer A and the gyroscope G. The fusion may be partial or complete. In this case, the determining means DET may be configured to determine the values of the components of the gravity vector from a rotation matrix obtained by fusion of measurements delivered by the accelerometer A and the gyroscope G.

The processing module TRT may be suitable for determining a neutral reference position from a mapping between the axes of the moving reference frame RM and the axes of the joystick equivalent, and an application of an offset to said components.

The application of an offset is used for adjusting the neutral position about which the angles of inclination of the mobile control element EM may vary.

This offset can be used to define a neutral reference orientation or position, e.g. for a driving game, the remote control could be held horizontally, while for a flying game, the remote control may be held like a vertical stick.

In addition, the mobile element EM may be provided with at least one physical or virtual button (e.g. represented on a touch screen), not represented in FIG. 1, mapped to the joystick equivalent buttons.

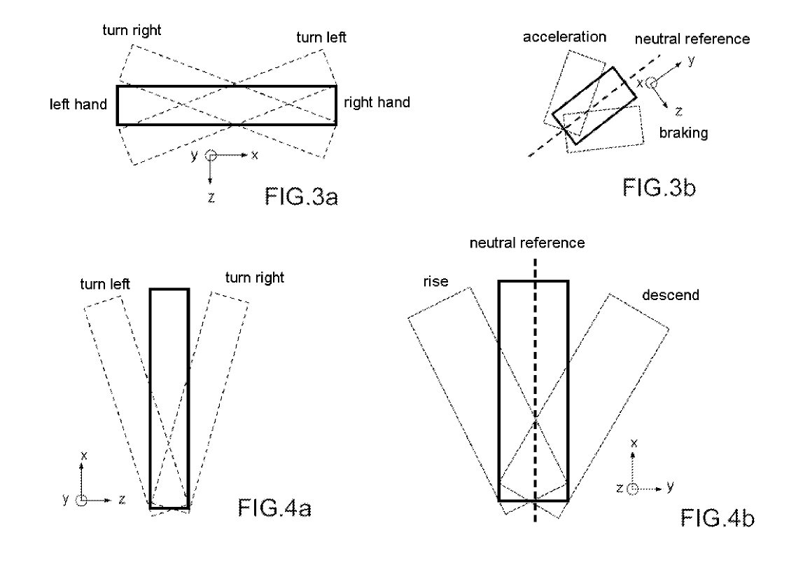

FIGS. 3a and 3b illustrate an example of a racing game in which the remote control is held horizontally (the user holds each end with one hand). The roll of the remote control (rotation about the y-axis) is used as a steering function (steering wheel), and may be converted into the x-axis of the control lever (left-right movement), as illustrated in FIG. 3a. The pitch of the remote control (rotation about the x-axis) may be used for accelerating and braking, as illustrated in FIG. 3b, and may be converted into the y-axis of the control lever (forward-backward movement). In the neutral reference position, the y-axis of the remote control may be inclined at an angle of 45° with respect to the gravity vector as represented in FIG. 3b.

FIGS. 4a and 4b represent an example of a flight simulation game in which the remote control is held vertically like a stick. The roll of the remote control (rotation about the y-axis) is again used as a steering function, and may be converted into the x-axis of the control lever (left-right movement). The pitch of the remote control, in this example rotation about the z-axis, may be used to rise or descend, and may be converted into the y-axis of the control lever (forward-backward movement). In this example, the neutral reference position of the remote control x-axis is the vertical position.

These examples show that according to the way in which the remote control is held by the user, rotations about different axes are converted into x and y of the axis of the control lever or joystick equivalent.

The neutral reference position may be defined by the application or game, e.g. for an automobile racing game, the system may define the horizontal position of the mobile control element as a neutral reference position.

Alternatively, the angles of the neutral reference position may be adjusted by the user when said user selects the orientation for an application, such as a game.

The system may check whether the user is holding the mobile control element EM more or less correctly for the application used, even before starting an action of the application, e.g. of a game. If the neutral starting position does not correspond to the application, the system may alert the user.

Another possibility includes defining the position at the launching of the application, e.g. of a portion of a game, as a neutral position. It is then desirable to check that the user is holding the graspable mobile control element EM, e.g. a remote control, in order to avoid situations in which the user has, for example, placed the remote control on a table, and catches hold of it just at the startup of the application.

FIG. 5 illustrates the main steps in the method for simulating a joystick equivalent with at least one control element with a physical stop, based on a graspable control element EM, according to an embodiment of the invention.

In a step Step1, the values of components of the gravity vector are determined along at least one axis of a moving reference frame RM tied to the mobile element. Then, in a step Step2, the components are converted into output signals corresponding to a joystick equivalent with at least one control element with a physical stop, by direct application of a gain, and, in a step Step3, said output signals are delivered corresponding to said joystick equivalent with at least one control element with a physical stop.

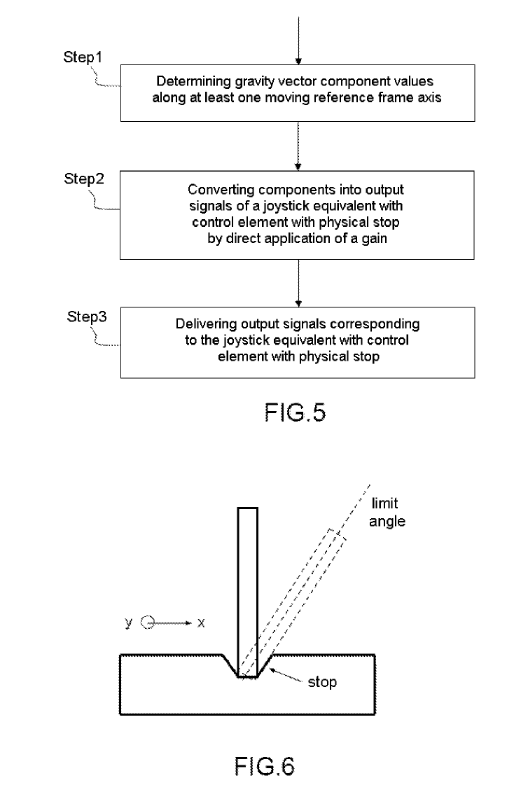

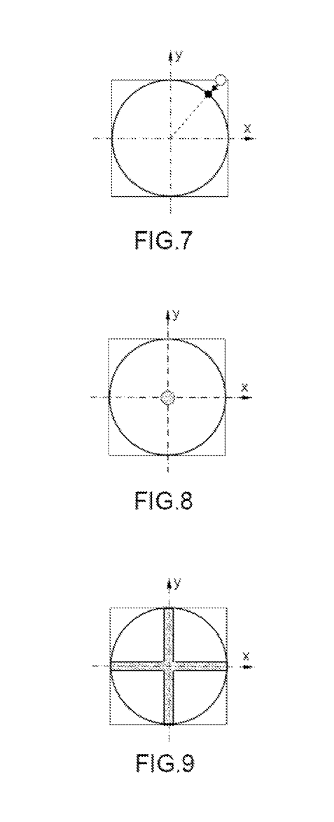

The processing means TRT may be configured to simulate a physical stop based on an angle limit beyond which the stop is deemed to be reached. FIG. 6 illustrates the mechanical stop and the limit angle of a control element of the joystick equivalent. Thus, for any movement of the user leading to exceeding this angle limit, the output signals simulate reaching a physical stop of the corresponding virtual joystick, as illustrated in FIG. 7. FIG. 7 corresponds to applying a Euclidean norm (2-norm) in which the limit is represented by a circle. This is due to the fact that in many cases, the mechanical stop has a circular symmetry. Other norms may be applied, such as the 1-norm or the infinity-norm.

FIG. 8 illustrates a dead zone of a mechanical joystick. The gray circle in the middle represents the dead zone in which the joystick movements are not transmitted as output. For emulating this case, a threshold angle is defined about the neutral reference position, below which the remote control movements do not change the output signals of the joystick.

In the case of a remote control there is more freedom for defining the dead zone. FIG. 9 illustrates an embodiment with two dead bands, represented as stippled regions, which means that the dead zone about the neutral position along the x-axis is not linked to the dead zone about the neutral position along the y-axis. This embodiment may make the most convenient use of the remote control. For example, in a racing game in which the roll of the remote control is mapped to the action of turning, and the pitch is mapped to acceleration and braking. This results in a dead zone about the neutral turning position, whatever the acceleration/braking position, and vice versa.

The position and shape of the dead zone may depend on the application and the preferences or experiences of the user.

In other words, said processing means TRT may be configured to not take into account (e.g., exclude), about the neutral reference position of the mobile element EM, angular movements, along at least one of the axes of the mobile element EM, below a respective threshold, as illustrated in FIG. 9. This simulates, independently on each axis, a ‘dead band’ avoiding taking into account small unwanted or unrepresentative movements, about the neutral reference position.

Thus, the degrees of freedom of the mobile control element, e.g. a remote control, give the user the opportunity to improve the use and performance of the mobile control element.

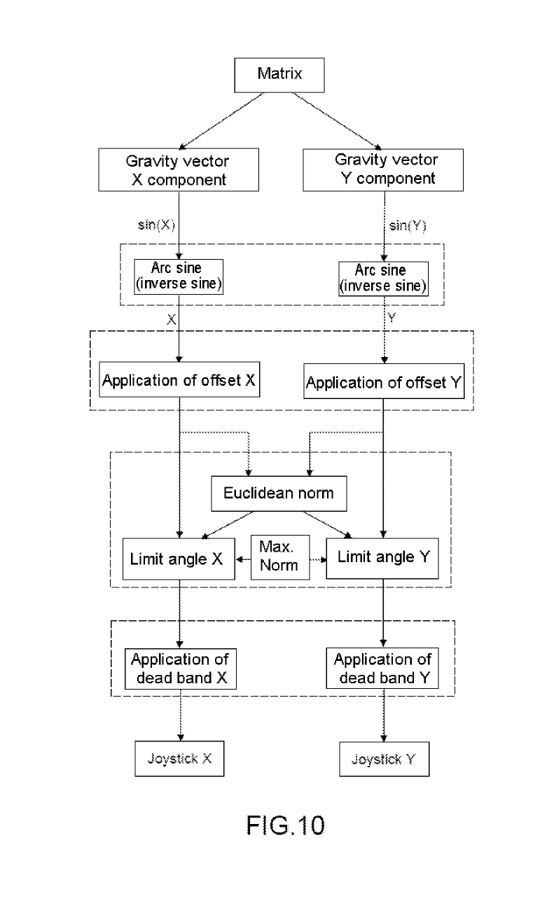

FIG. 10 schematically illustrates an example of complete embodiment, with all the optional elements.

The process starts by extracting two components, the X component and the Y component of the gravity vector of the attitude matrix. The object is to convert these components into a first datum X and a second datum Y which represent the usual outputs of joysticks with at least one control element with a physical stop, according to the usual standards. X and Y represent the angles of the mobile control element, e.g. a remote control, and the X components and Y components represent sin(X) and sin(Y).

From the components of the gravity vector, it is possible to obtain the angles of the mobile control element by direct application of the inverse sine function. However, for small angles, which is common in video games, it is possible to approximate an angle by the sine thereof, also, the application of the inverse function is optional.

In a variant, as illustrated in FIG. 10, the values of X and Y may be extracted by direct application of the inverse sine function.

It is possible to apply an offset on X and Y for setting the parameters of a neutral reference position corresponding to the released position of the corresponding joystick.

After the neutral reference position has been defined it is possible to check whether the angle of the mobile control element does not exceed the angle defined by the stop. In this example, a Euclidean norm is applied for simulating a circular mechanical stop (explained above in the description of FIG. 7).

Finally, it is possible to apply one or two dead bands independently on X and Y infiltrated by small gestures not wanted by the user.

Then signals are output equivalent to the X and Y data signals output from a joystick or joystick with at least one control element with a physical stop, directly usable by an application, notably a game, without having to modify the latter.

The signals are transmitted to the operating system, and used in the game which is now controlled by the mobile control element, such as a remote control, as if it were a joystick with a mechanical stop.

In the example above, two degrees of freedom x and y are used, corresponding to the standard movements of the joystick in two dimensions. In some joysticks, the control element itself can be rotated about its axis, giving a third degree of freedom. It is possible to use the third axis of rotation of the remote control, and to map this angle of rotation with the rotation of the joystick equivalent control element. Therefore, in this case, there are three degrees of freedom (rotations) of the remote control, which are mapped to the three degrees of freedom of the joystick equivalent control element. The processing of this third degree of freedom is identical to the others (offset, angle limit, dead band).

FIG. 2b illustrates a joystick which includes two small control elements with a physical stop, often controlled by the user's thumbs. The joystick sends the positions of these two control elements with a physical stop to the operating system. It is possible to add motion detectors to the joystick itself for adding additional degrees of freedom for users' movements. The movements of the joystick can be converted into joystick equivalent signals as provided in the present invention. This means that the controller can send three joystick signals to the operating system: two for the actual control elements on the joystick, and an additional one for indicating the movements of the joystick itself.

In many cases, the joystick equivalent is provided with buttons, if the mobile device is also provided with buttons (real or virtual (e.g. touch)), the buttons on the device, e.g. a remote control, may be mapped to the joystick equivalent buttons. The mapping may depend on the application, the user's preferences, and the way in which the user holds the device in order to be ergonomic.

What is claimed is:

1. A control system with a graspable mobile control element, including:
a determining system configured to determine values of components of a gravity vector along at least one axis of a moving reference frame tied to the mobile element, the determining system including a motion sensor assembly having an accelerometer with at least one axis for measurements and a gyroscope with at least one measurement axis, the determining system utilizing measurements delivered by the accelerometer and the gyroscope to obtain the values of the components of the gravity vector;
a processor configured to convert, by direct application of a gain, said components into output signals corresponding to those of a joystick equivalent provided with at least one control element with a physical stop; and
an output system configured to provide said output signals corresponding to said joystick equivalent with at least one control element with a physical stop to another device.

2. The system as claimed in claim 1, wherein said processor is further configured to determine a neutral reference position from a mapping between the axes of said moving reference frame and the axes of said joystick equivalent, and from an application of an offset to said components.

3. The system as claimed in claim 2, wherein said processor is further configured to not take into account, about the neutral reference position of the mobile element (EM), angular movements, along at least one of the axes of the mobile element, below a respective threshold.

4. The system as claimed in claim 1, wherein said processor is further configured to simulate said physical stop based on an angle limit beyond which said stop is deemed to be reached.

5. The system as claimed in claim 1, wherein said determining system is further configured to determine said values of said components of the gravity vector from an attitude matrix obtained by utilizing measurements delivered by the accelerometer and the gyroscope.

6. The system as claimed in claim 1, wherein said motion sensor assembly further includes a magnetometer.

7. The system as claimed in claim 1, wherein said mobile element is provided with at least one physical or virtual button, mapped to the buttons of said joystick equivalent.

8. The system as claimed in claim 1, wherein said mobile element is a remote control, a mobile phone, a touch pad, or a joystick provided with at least one motion sensor.

9. A method for simulating a joystick equivalent with at least one control element with a physical stop, based on a graspable control element, of the method comprising:
determining values of components of a gravity vector along at least one axis of a moving reference frame tied to the mobile element, from data supplied by a motion sensor assembly including an accelerometer with at least one axis for measurements and a gyroscope with at least one measurement axis, by fusion of measurements delivered by the accelerometer and the gyroscope;
converting, by direct application of a gain, said components into output signals corresponding to those of a joystick equivalent with at least one control element with a physical stop; and
delivering said output signals corresponding to said joystick equivalent with at least one control element with a physical stop.
